(19) United States
(12) Patent Application Publication
(10) Pub. No.: US 2016/0355333 A1
(43) Pub. Date: Dec. 8, 2016

(54) DISPENSING PACKAGE FOR TRASH BAGS

(71) Applicant: Umm Al-Qura University, Makkah (SA)

(72) Inventor: Asrar Abdullah Al Umayri, Makkah (SA)

(21) Appl. No.: 14/729,804

(22) Filed: Jun. 3, 2015

(51) Int. Cl. B65F 1/14

(52) U.S. Cl. CPC B65F 1/1436

(57) ABSTRACT

A dispenser for dispensing a trash bag directly into a trash receptacle. The dispenser has a base member with a top wall, side wall and bottom wall. A plurality of bags in the base member are releasably connected end-to-end so that pulling one bag from the dispenser automatically pulls a succeeding bag from the dispenser. The dispenser top wall has an opening through which a bag can be withdrawn to engage a top end of the bag with the top end of the receptacle while leaving a lower end of the bag attached to a succeeding bag in the dispenser. A membrane closes the opening in the base member to prevent entry of dirt and debris into the base member, and an opening is formed in the membrane to permit a bag to be withdrawn from the base member through the membrane.

### TECHNICAL FIELD

This invention relates to trash bag holders and dispensers, and particularly to a trash bag holder and dispenser in which trash bags can be withdrawn from the top of the dispenser and the dispenser is designed to be kept in the bottom of a trash receptacle.

### BACKGROUND ART

Trash receptacles are used in the home, offices, restaurants, and other public places. In most cases a liner or trash bag is placed in the receptacle to receive the trash and when full the liner is removed and replaced with a fresh one. A supply of trash bags generally is kept in a location separate from the trash receptacle, frequently in a place dedicated to that purpose.

In most residences trash bags are removed when they are full. After the full trash bag is removed a new trash bag must be found so that it may be positioned in the trash container. In most institutions and corporations trash bags are replaced on a scheduled cleaning cycle. The frequency of trash bag removal and replacement must be sufficient to ensure that even during periods of heavy use that collected trash is removed before the trash container is full. Empty trash bags are not generally available to users. Trash bags are usually removed and replaced by cleaning personnel when they are substantially less than half full.

Some systems have been developed in the prior art for storing a supply of trash bags in close association with the trash receptacle in which the bags will be used. Examples are described in published US patent application serial numbers 2004/0262316, 2005/0029281, 2005/0092753, 2007/0227924, 2009/0236345, and 2010/0276428, U.S. Pat. Nos. 4,798,363, 5,353,950, 5,671,847 5,738,239 and 7,168,591, published international application WO 1999/020547, and European patent EP 1775239.

Published application 2005/0029281 discloses a waste bag dispenser which can be universally fitted within any waste container having a generally flat central bottom portion. The dispenser comprises a base member designed to hold a roll of waste bags such as those commonly available at retail establishments. The base member has an upper side portion with a bag dispensing opening therein, and a removable and re-attachable strip for attachment of the housing to the waste container. After a first bag is pulled from the waste bag dispenser, subsequent bags are automatically pulled therefrom when a preceding bag is removed from the waste container.

Published European patent EP 1775239A1 discloses a refill pack for a refuse container wherein a waste bin (1) has a pack (4) of bin liners folded zigzag-fashion and attached to its base by adhesive strips. The liners are connected so that a fresh liner (5) is dispensed as a full one (6) is removed.

U.S. Pat. No. 5,738,239 discloses a waste container which contains a panel at the bottom, forming a tube having one end blocked and the other end open. A slot in the panel extends the length of the tube and has an open end beyond the open end of the tube. Finger grips in the panel beyond the open end of the tube enable one to tilt up the open end of the slot for simultaneously loading a roll of liner bags in the tube and retrieving one bag at a time from the slot.

Published international application WO 1999/020547 discloses a refillable dispenser of waste bags characterized in that the refillable dispenser is an openable sub-base (a2) of a waste container (A), said container having an open bottom allowing passage of one bag at time from the sub-base (a2) into the upper part (al) of the waste container (A), while the remaining bags remain in the sub-base.

Published application 2005/0092753 discloses a waste bag dispenser for use in a waste receptacle to dispense a fresh waste bag as a full one is removed. The dispenser has a cavity for receiving a series of bags, a cover including a slot for allowing waste bags to be removed from the cavity, and a contact surface preventing separation between the dispenser and the waste receptacle during removal of waste bags from the cavity. The dispenser provides for use in which a first waste bag is removed from the receiving cavity through the slot and arranged in the receptacle to hold waste and is removed from the receptacle causing a second waste bag to be removed from the receiving cavity through the slot to allow arrangement of the second waste bag in the receptacle to hold waste.

U.S. Pat. No. 4,798,363 discloses a wastebasket that is modified to hold a roll of liner bags below the bottom of the wastebasket. The bags are fed through a slot in the bottom to permit replacement of a first bag with a succeeding bag in the roll. When a full bag is removed from the container, the succeeding bag is automatically pulled into the enclosure, and it may be removed by simply tearing at a perforated line.

U.S. Pat. No. 7,168,591 discloses a waste bag dispenser for placement in a waste receptacle and dispensing waste bags one at a time. The dispenser comprises a housing for containing the waste bags and a cover having a slot therein for guiding the waste bags therethrough. The dispenser is attachable to an interior of the waste receptacle with an adhesive backed hook and loop type fastener.

Published application 2009/0236345 discloses a waste receptacle that is divided into an upper part and a lower part, wherein the divider defines a hole that passes therethrough, and a plurality of bags connected in series are stored in the lower part so that the bags may be pulled individually through a hole of the divider, such that the first bag will pull the second bag through the divider.

Published application 2004/0262316 discloses a refuse container that has a dispensing aperture formed on a bottom inside surface thereof, with a holding member disposed beneath the bottom surface for holding bags. The bags can be arranged in a coil configuration within the holding member and can be pulled through the dispensing aperture to line an inside surface of the refuse container.

U.S. Pat. No. 5,353,950 discloses a flexible, collapsible waste bag dispenser attached to the bottom of a waste can by an adhesive tape. The waste bags are connected in a string and stored in the dispenser with the last bag being connected to the pouch. The waste bags are pulled out one at a time, and expanded in the container. When the expanded waste bag is full of waste, it is removed from the container, pulling up the next bag to replace the full waste bag. The process continues until the last bag, which is marked, indicates the end of the string of bags. The last waste bag is attached to the pouch so that they can be removed together when the last waste bag is full. The flexible pouch is collapsed as waste is delivered into the bag.

U.S. Pat. No. 5,671,847 discloses a waste bag dispenser in the form of a pouch that has an adhesive strip on the bottom for mounting to the interior of a waste container and an opening on the top to provide access to a continuous strip of waste can liners which are folded in an accordion like manner within the pouch. The pouch is thinly formed of a plastic film.

Published application 2010/0276428 discloses a waste dispenser that includes a waste receptacle and a container of waste bags disposed at the bottom of the receptacle. A user can reach down through the receptacle and pull an uppermost bag from the container and fold it over a top rim of the receptacle to form a liner for the receptacle. The bag container may be slid into the bottom of the receptacle through a side opening in the receptacle side wall. Alternatively, the bag container can be removably attached to the receptacle beneath a lower end thereof.

To minimize time consumed in obtaining and replacing trash bags, and to promote complete and efficient use of trash bags, a trash bag dispenser which automatically replaces trash bags is needed. Most preferably, the trash bag dispenser should allow an existing trash container to be retrofitted. And most importantly, the trash bag dispenser must be easily and completely removable from the trash container to facilitate intermittent cleaning in the event of trash bag breakage. Removal also facilitates replacement of bags within the trash bag dispenser. Finally, the trash bag dispenser should be sufficiently substantial so that it will not collapse when it bears the weight of a heavily loaded bag of trash, and it should be sufficiently closed during use that trash and other debris will not get into it. It is necessary that a trash bag be able to be dispensed when a fully loaded bag of trash is supported by the trash dispenser positioned in the bottom of the trash container.

### SUMMARY OF THE INVENTION

The present invention provides a trash bag dispenser that is kept in the trash receptacle so that no time is spent retrieving a fresh bag from a remote storage location. Also, it enables a fresh bag to be automatically positioned for use whenever a previous bag is removed from the receptacle.

The dispenser of the invention takes up a minimal amount of space in the trash receptacle and is made of a strong, durable material that can withstand the weight of a full bag resting on it. Further, the dispenser can be removed from the trash receptacle to be refilled with fresh bags when it is empty and/or to enable the trash receptacle to be cleaned. The trash bag dispenser of the invention can easily be produced in different sizes to accommodate different size bags. It also remains sufficiently closed during use that trash and other debris will not get into it.

The trash bag dispenser can be made in any suitable and desired size, most commonly having a diameter from approximately 25 cm to 56 cm (about 10 inches to 22 inches).

In another embodiment, a collapsible trash receptacle and bag dispenser are integrated into one device.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a top isometric view of a first form of bag dispenser according to the invention.

FIG. 2 is a side view in elevation of the dispenser of FIG. 1.

FIG. 3 is a bottom plan view of the dispenser, showing the tape used to attach the device to the bottom of a trash receptacle.

FIG. 4 is a top plan view of the device, showing the closure and slit in the top wall through which fresh bags are withdrawn from the device.

FIG. 5 is an isometric view of a roll of fresh bags.

FIG. 6 is an exploded view of the dispenser, with a portion broken away to show one possible means for releasably attaching the top wall to the side wall, and showing the top wall removed for placement of a fresh supply of trash bags in the dispenser.

FIG. 7 is a top isometric view of another form of the invention.

FIG. 8 is an exploded view of the components of that form of the invention shown in FIG. 7.

FIG. 9 is a top isometric view of a further form of the invention wherein the trash receptacle is integrated with the bag dispenser and is expandable and collapsible.

FIG. 10 is a view similar to FIG. 9, with the receptacle partially collapsed.

FIG. 11 is a view similar to FIG. 9, with the receptacle fully collapsed.

FIG. 12 is an exploded view of that form of the invention in FIGS. 9-11, with the base member shown inverted and the bottom removed.

### DETAILED DESCRIPTION OF THE PREFERRED EMBODIMENTS

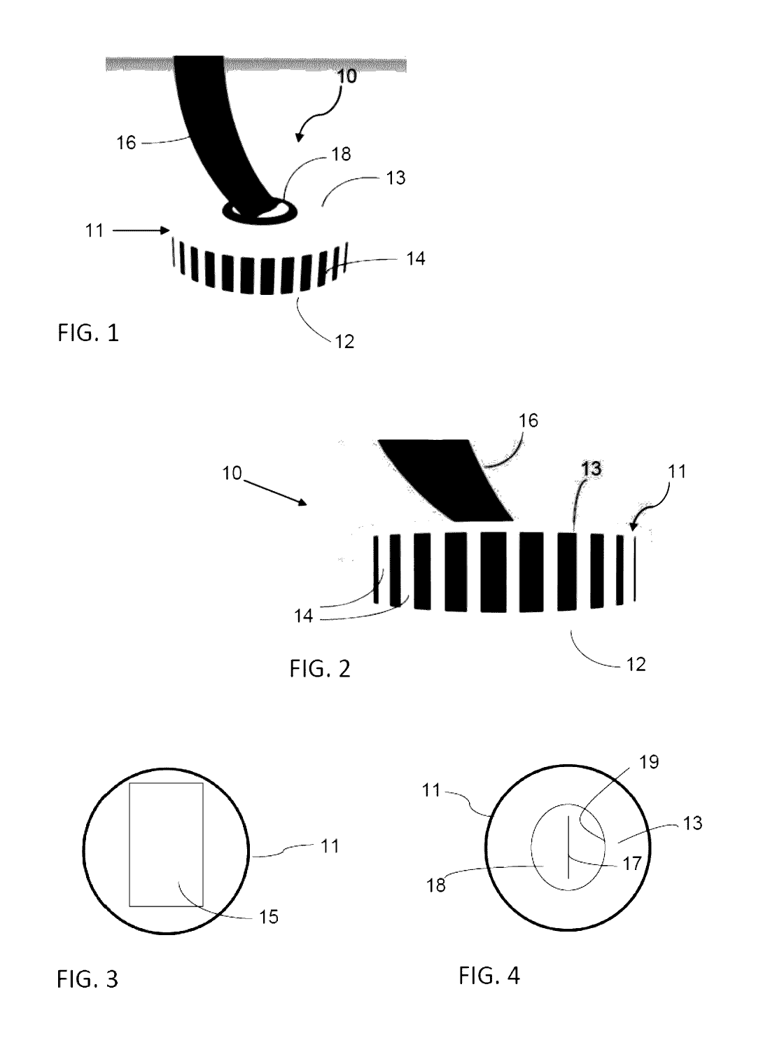

A first form of bag dispensing device in accordance with the invention is indicated generally at 10 in FIGS. 1-5. In this form of the invention the dispenser comprises a housing having a circular, disc-shaped base member 11 with a bottom wall 12 and a top wall 13 supported in vertically spaced relation to one another by a plurality of vertical ribs 14 extending around the outer periphery of the base member and forming an outer circumferential side wall.

Suitable means can be provided for removably attaching the dispenser to the bottom of a trash receptacle. As shown in FIG. 3, this can preferably comprise a piece of double face tape 15 adhered to the bottom of the base member 11. In use, a dispenser 10 loaded with a supply of fresh trash bags can be placed in the bottom of a trash receptacle (not shown) and pressed downwardly to attach the dispenser to the bottom of the receptacle. Alternatively, other suitable releasable adhesive means, or Velcro or other temporary fastening means could be used.

Fresh trash bags 16 are pulled from the base member 11 through a slot 17 in a membrane 18 closing an opening 19 through the top wall 13. Although in the particular example illustrated, a slot 17 is formed in the membrane, other types of access known in the art as used on dispensers for antiseptic wipes, napkins and the like can be used if desired. The membrane closes the opening 19 to prevent dirt and other debris from falling into the dispenser. The dispenser 10 can be opened to place a roll of fresh trash bags in it by removing the top 13, and inserting an end of the leading bag 16 through the slot 17.

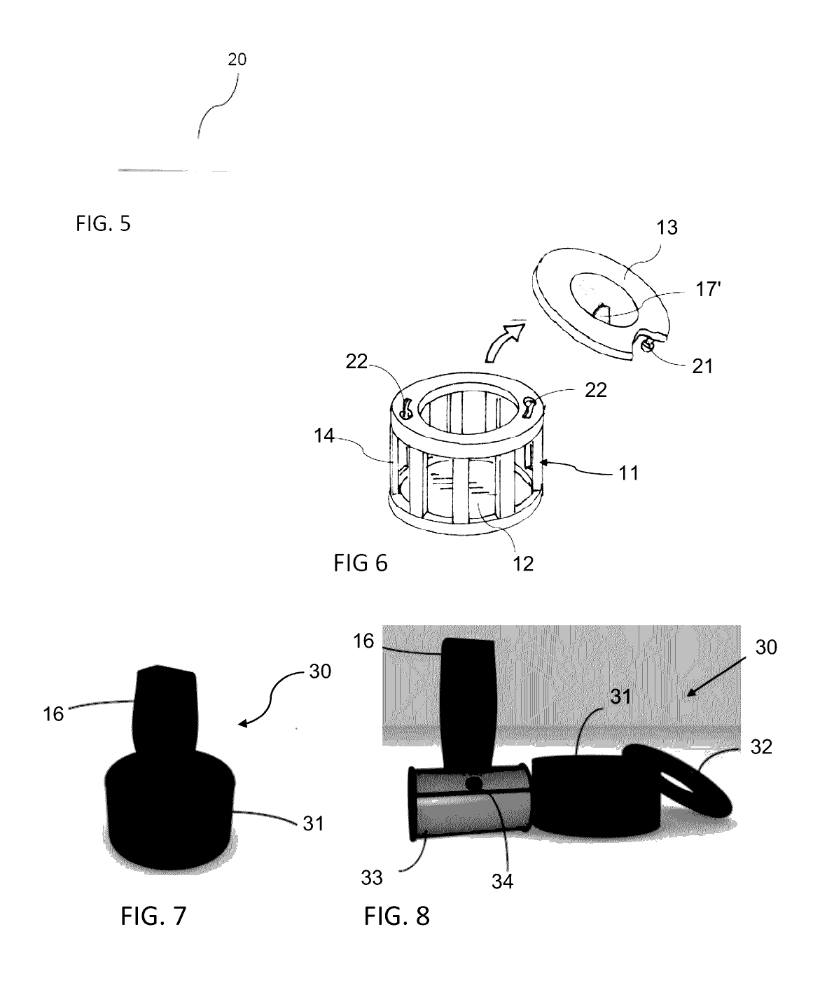

As shown in FIG. 5, a roll of trash bags can be placed in a tube 20, which can be refillable or thrown away when empty and a new tube purchased that is pre-filled with fresh bags. The type of supply of fresh bags is not critical and any suitable commercially available supply of bags can be used, preferably with a roll of bags releasably connected together at adjacent ends so that when a bag is pulled from the roll to be placed in the trash receptacle for receiving waste material, a succeeding bag is automatically pulled into position to next be positioned for receiving waste material.

As shown in FIG. 6, the top 13 can be removed from the base by rotating it slightly to disengage pins 21 from slots 22 so that a tube filled with fresh bags can be placed in the dispenser. Although only one pin is shown in FIG. 6, an identical pin is provided on the diametrically opposite side of the top 13. It should be understood, however, that only one pin and slot could be provided, or an entirely different means could be provided for releasably attaching the top 13 to the base. The end of the lead bag on the roll is fed through the slot 17 in the membrane 18 in the top wall 13 and the top wall is then replaced on the base. The dispenser is then placed in the trash receptacle and the lead bag pulled out of the dispenser so that the open upper end of the bag can be attached to the open upper end of the trash receptacle. When that bag is full, it is removed from the trash receptacle. The bags on the roll are all releasably attached together end-to-end, and when a full bag is removed from the trash receptacle it pulls the next fresh bag from the dispenser and positions it ready to be attached to the top of the trash receptacle.

The dispenser 10 can have any suitable size, and in one example the base member has an outer diameter of from about 10 inches to about 22 inches and a height of from about 3 inches to about 7 inches, depending upon the size of trash receptacle and the related size of the trash bags.

Another form of the invention is shown at 30 in FIGS. 7 and 8. In this form of the invention the dispenser comprises a cup-shaped base member 31 with a bottom wall and a removable lid or cover 32 forming a top wall. A trash bag cartridge 33 containing a roll of trash bags 16 is placed in the base member, with the end of the leading bag on the roll pulled through a slot in the side of the cartridge. Although not shown, a membrane may close the opening through the center of the cover 32 to keep dirt and debris from falling into the dispenser as in the previous embodiment, and a slit or other suitable opening (not shown) through the membrane enables the end of the lead bag to be pulled through the membrane as shown in FIG. 6. The cartridge may be opened to refill it by operating a latch 34.

Although not shown, a piece of double face tape or other suitable means may be provided on the bottom of the base 31 to attach the dispenser to the bottom of a trash receptacle as in the first embodiment, depicted in FIG. 3.

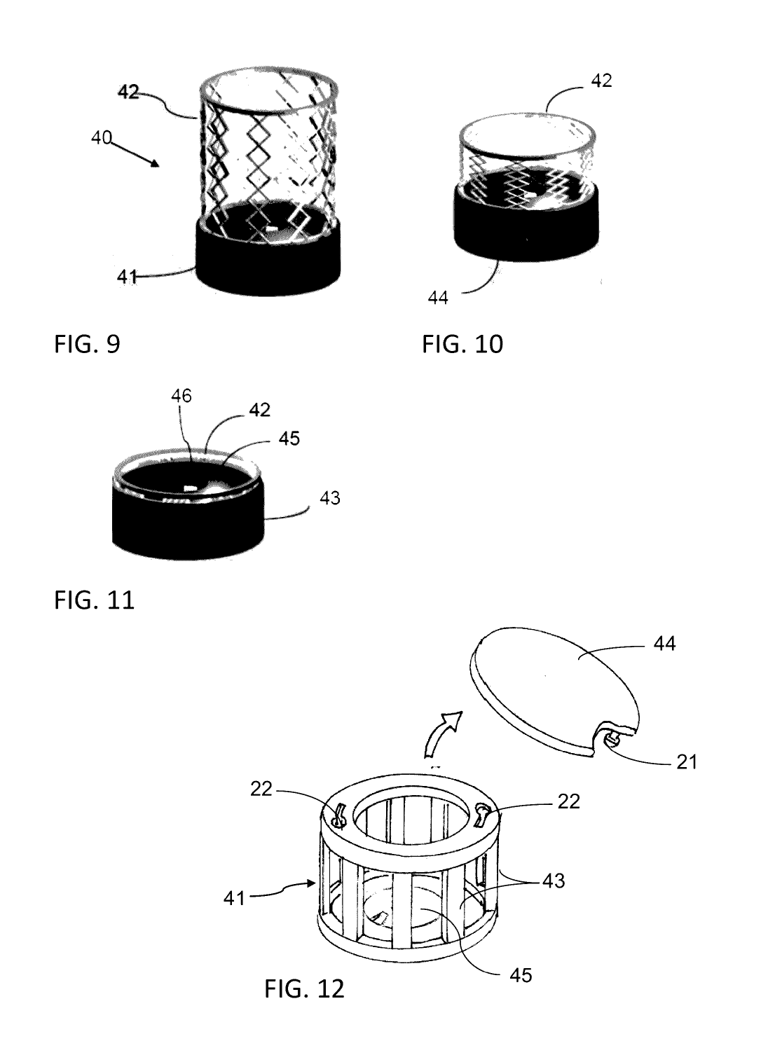

A third form of the invention is indicated generally at 40 in FIGS. 9-12. This form differs from the previous forms in that the dispenser base member 41 is integrated with a trash receptacle 42 and comprises the bottom wall for the receptacle, with the receptacle side wall attached to and extending upwardly from the outer margin of the dispenser base member. The base member is essentially the same as that shown in FIGS. 1-4 in that it has a circular disc-shape with a bottom wall 44, a top wall 45, and a plurality of vertically extending ribs 43 extending between and connecting the top and bottom walls. An opening 46 through the top wall is closed by a membrane (not shown) as in the embodiment shown in FIGS. 1-4. As in the embodiments described above, a slit or notch or other means known in the art in the membrane allows the bags to be withdrawn from the base.

The base 41 is shown inverted in FIG. 12, with the collapsible receptacle 42 omitted for purpose of simplicity of illustration. In this form of the invention, the bottom 44 can be removed by disengaging pins 21 from slots 22 in order to put a new supply of fresh trash bags in the base.

The receptacle 42 is collapsible from a fully extended height shown in FIG. 9, to a fully collapsed position shown in FIG. 11. FIG. 10 shows the receptacle in a partially collapsed or expanded position.

The components of the dispenser can be made of any suitable material, although rubber and/or plastic are preferred. In particular embodiments, the dispenser shown in FIGS. 1-5 is made of rubber and the dispenser shown in FIGS. 8-11 is made of plastic.

While particular embodiments of the invention have been illustrated and described in detail herein, it should be understood that various changes and modifications may be made in the invention without departing from the spirit and intent of the invention as defined by the appended claims.

1. A dispenser for dispensing a fresh trash bag directly into a trash receptacle having a side wall and a top end, said dispenser comprising:
a base member having sufficient rigidity to support the weight of a full trash bag resting on top of it;
said base member having a top wall, a bottom wall, and a side wall, said side wall comprising a plurality of parallel spaced apart ribs extending between the top wall and bottom wall defining a side wall that is open between said ribs;
a plurality of trash bags in said base member, said trash bags releasably connected end-to-end so that pulling one trash bag from the base member automatically pulls a succeeding trash bag from the base member;
said dispenser top wall having an opening in it through which a trash bag can be withdrawn from said base member to engage a top end of said trash bag on the top end of a trash receptacle when said dispenser is positioned in a trash receptacle, while leaving a lower end of said trash bag attached to a succeeding bag in said dispenser;
a membrane closing said opening in said base member top wall to prevent entry of dirt and debris into said base member through said opening; and
means formed in said membrane for permitting a bag to be withdrawn from said base member through said membrane.

2. A dispenser as claimed in claim 1, wherein:
means is on the bottom wall of said base member for releasably securing said dispenser to an inside surface of a trash receptacle bottom wall when said dispenser is placed in a trash receptacle.

3. A dispenser as claimed in claim 2, wherein:
said base member top wall is removably attached to said base member side wall so that it may be removed to enable placement of a fresh supply of trash bags in said dispenser.

4. A dispenser as claimed in claim 3, wherein:
said base member top wall and side wall have interengaged pins and slots to attach said top wall to said side wall, said top wall being rotatable to disengage said pins from said slots and free said top wall from said side wall.

5. (canceled)

6. (canceled)

7. A dispenser as claimed in claim 11, wherein:
said receptacle side wall is collapsible from a full height position to a position collapsed on top of said dispenser base member.

8. A dispenser as claimed in claim 7, wherein:
said base member bottom wall is removably attached to said base member side wall so that it may be removed to enable placement of a fresh supply of trash bags in said dispenser.

9. A dispenser as claimed in claim 8, wherein:
said base member bottom wall and side wall have interengaged pins and slots to attach said base member bottom wall to said base member side wall, said base member bottom wall being rotatable to disengage said pins from said slots and free said base member bottom wall from said base member side wall.

10. A dispenser as claimed in claim 7, wherein:
said receptacle side wall comprises a plurality of circumferentially spaced, articulated scissor-folded members connected at their bottom ends to said marginal edge of said base member and at their top ends to an annular ring.

11. A combined trash receptacle and trash bag dispenser for dispensing a fresh trash bag directly into the trash receptacle, wherein:
said trash receptacle has a side wall and a top end; and
said dispenser comprises a base member having sufficient rigidity to support the weight of a full trash bag resting on top of it;
said base member having a top wall, a bottom wall, and a side wall, said trash receptacle side wall being attached at a bottom end thereof to a marginal edge of said dispenser base member, said base member forming a bottom wall of said trash receptacle;
a plurality of trash bags in said base member, said trash bags releasably connected end-to-end so that pulling one trash bag from the base member automatically pulls a succeeding trash bag from the base member;
said dispenser top wall having an opening in it through which a trash bag can be withdrawn from said base member to engage a top end of said trash bag on said top end of said receptacle side wall while leaving a lower end of said trash bag attached to a succeeding bag in said dispenser;
a membrane closing said opening in said base member top wall to prevent entry of dirt and debris into said base member through said opening; and
means formed in said membrane for permitting a bag to be withdrawn from said base member through said membrane.
